(19) United States
(12) Patent Application Publication
(10) Pub. No.: US 2017/0010604 A1
(43) Pub. Date: Jan. 12, 2017

(54) OPERATING PANEL DEVICE FOR MACHINING TOOLS

(71) Applicant: Doosan Machine Tools Co., Ltd., Chang-won-si (KR)

(72) Inventor: Seong-Hoon JEONG, Gimhae-si (KR)

(21) Appl. No.: 15/204,996

(22) Filed: Jul. 8, 2016

(30) Foreign Application Priority Data
Jul. 8, 2015 (KR) 10-2015-0097367

(51) Int. Cl. G05B 19/414; F16M 11/08; F16M 13/02; F16M 11/20

(52) U.S. Cl. CPC G05B 19/414; F16M 11/2085; F16M 11/08; F16M 13/02; G05B 2219/39427

(57) ABSTRACT

Disclosed is an operating panel device for a machining center having a length in a first direction and a width in a second direction. The operating panel device includes an operating interface having a panel that communicates with the machining center and a panel support that supports and secures the panel, a linear transfer arranged at a longitudinal side of the machining center and extending in the first direction, and a rotating coupler coupling the operating interface to the linear transfer and conducting a linear motion along the first direction and a rotating motion with respect to a third direction perpendicular to the first and the second directions such that the operating interface is selectively positioned at one of the longitudinal side and a latitudinal side of the machining center.

### PRIORITY STATEMENT

This application claims priority under 35 U.S.C §119 to Korean Patent Application No. 10-2015-0097367 filed on Jul. 8, 2015 in the Korean Intellectual Property Office, the contents of which are hereby incorporated by reference in their entirety.

### BACKGROUND

1. Field

Example embodiments relate to an operating panel device for machining tools, and more particularly, to an operating panel device for a machining center.

2. Description of the Related Art

Most of recent mechanical products tend to be manufactured under mass production systems with high precision in a range of various sizes and configurations from small and minute machine parts to tremendous large-scale mechanical structures. For that reason, various numerical control machines have been widely used for machining the mechanical products in which most of the significant machining processes for manufacturing the mechanical products can be automatically controlled under numerical control algorithms.

Particularly, recent machining tools have been developed to a machining center in which processing machines are provided together with supporting machines such as an automatic tool changer (ATC) and an automatic attachment changer (AAC) and the processing machines and the processing machines and the supporting machines are automatically controlled under the same numerical controller. The ATC changes the machining tools that are combined to the processing machine automatically according the cutting requirements to a machining object and the AAC changes the tool attachments for the tool automatically according to the tool selection of the ATC. Thus, the multi-axis machining and the multi-process machining can be automatically conducted in the machining center according to a digital-based machining layout.

Most of the machining center usually may have an operating panel device as a user interface for communicating with the numerical controller. The operators of the machining center may verify the operating states and conditions of the machining center by using the operating panel device and may apply some instruction signals for operating the machining center to the numerical controller through the operating panel device.

In conventional machining centers, the machining object is secured to a movable table on a stationary bed and the machining tools are combined to a stationary/movable spindle assembly. Thus, the machining object is usually processed by the relative motions between the machining object and the machining tools in the machining center.

The operating panel device is usually arranged at a longitudinal side of the machining center and the operator of the machining center controls the machining center via the operating panel device while watching on the machining conditions such as the processing steps and machining states of the machining objects in the machining center. The conventional operating panel device includes a bracket secured to an exterior of the housing of the machining center, a support combined to the bracket and an operating panel flexibly extending from the support to an operation height corresponding to the height of an individual operator. Thus, the operating panel can be sufficiently secured to the exterior of the machining center by the bracket.

However, the stationary secure of the operating panel device to the exterior of the machining center may cause various problems when transferring the machining center, which may result in the increase of the transfer cost.

Since the operating panel device is secured to the longitudinal side of the machining center, a packaging space for packaging or wrapping the machining center may necessarily increase as long as the width of the operating panel device in a latitudinal direction of the machining center when the machining center is shipped out from the factory. A conventional cargo box of transfer vehicles may be flexible and elongated in a longitudinal direction and thus the machining center can be sufficiently loaded into the cargo box by using various cargo supplements even when the package length of the machining center is over an allowable length of the cargo box. However, a width of the cargo box is strictly limited under traffic regulations and thus the machining center is hardly transferred by the transfer vehicle when the package width of the machining center is over an allowable width of the cargo box. In such a case, the machining center can be transferred by parts or modules or by using any special transfer systems, any of which may tremendously increase the transfer cost of the machining center. In addition, the excessive package width of the machining center due to the operating panel device may also increase the packaging cost of the machining center.

Since the entrance or the opening gate of the machining center is usually arranged at the longitudinal side portion, the operation efficiency and conveniences of the machining center is severely deteriorated when the operating panel device is secured to a latitudinal side of the machining center. In addition, when the operating panel device may be individually transferred apart from the machining center and then may be assembled with the machining center after the transfer, the operating panel device tends to be inaccurately connected to the numerical controller of the machining center and thus the connection failures may frequently occur between the operating panel device and the numerical controller, which may significantly reduce the operation reliability and stability of the machining center.

That is, the conventional secure of the operating panel device to the longitudinal side of the machining center may cause significant increase of the transfer cost and the modified secure of the operating panel device to the latitudinal side of the machining center may cause the inconveniences and efficiency decrease of the machining center.

Accordingly, there has been a need for an improved operating panel device which is still provided at the longitudinal side of the machining center without any increase of the package width of the machining center in the latitudinal direction.

### SUMMARY

Example embodiments of the present inventive concept provide an operating panel device for a machining center which may be selectively arranged at one of a longitudinal side and a latitudinal side of the machining center, thereby reducing the packaging width and transfer cost of the machining center.

According to exemplary embodiments of the inventive concept, there is provided an operating panel device for a machining center having a length in a first direction and a width in a second direction. The operating panel device includes an operating interface having a panel that may communicate with the machining center and a panel support that may support and secure the panel, a linear transfer arranged at a longitudinal side of the machining center and extending in the first direction, and a rotating combiner coupling the operating interface to the linear transfer and conducting a linear motion along the first direction together with a rotating motion with respect to a third direction substantially perpendicular to the first and the second direction in such a configuration that the operating interface may be selectively positioned at one of the longitudinal side and a latitudinal side of the machining center.

In example embodiments, the linear transfer may include a linear motion (LM) guide rail extending in the first direction at the longitudinal side of the machining center and a guide block movably combined with the LM guide rail in such a configuration that the guide block may move in the first direction along the LM guide rail.

In example embodiments, the rotating coupler may include a securing plate secured to the guide block and moving in the first direction together with the guide block, a rotating plate to which the panel support may be secured and a joint member rotatably jointing the rotating plate to the securing plate.

In example embodiments, the joint member may include a plurality of hollow joint pieces combining across edge portions of the securing plate and the rotating plate and extending in the third direction and a connecting rod penetrating through the hollow joint pieces in the third direction in such a configuration that the rotating plate may rotate with respect to the connecting rod.

In example embodiments, the operating panel device may further include a rotation stopper detachably coupled to both of the securing plate and the rotating plate when the rotating plate may be spaced apart from the securing plate, thereby preventing the rotating plate from rotating back toward the securing plate, so that the operating interface may be forcibly positioned at the latitudinal side of the machining center.

According to example embodiments of the present inventive concept, the rotating coupler may be coupled to the linear transfer moving in the longitudinal direction of the machining center and simultaneously the operating interface may be coupled to the rotating coupler. When packaging the machining center for the factory shipment, the packaging worker may push the operating interface to the end along the linear transfer in the first direction, and then may rotate the operating interface with respect to the connecting rod of the joint member. As a result of the rotation, the operating interface may move to the latitudinal side from the longitudinal side of the machining center as a result of the rotation of the rotating plate. Thus, the packaging space for the machining center may be reduced as wide as the width of the operating interface just by the rotation of the rotating plate.

Accordingly, merely rotation of the operating interface may significantly reduce the packaging cost and the transfer cost of the machining center.

### DESCRIPTION OF THE DRAWINGS

These and other features of the inventive concept will become more apparent by describing in detail exemplary embodiments thereof with reference to the accompanying drawings of which:

FIG. 1 is a perspective view illustrating an operating panel device in accordance with an example embodiment of the present inventive concept in which the operating panel device is arranged at a longitudinal side of the machining center;

FIG. 2 is a perspective view of the operating panel device in FIG. 1 in which the operating panel device is rotated to a latitudinal side of the machining center;

FIG. 3A is a perspective view illustrating an assembly of a linear transfer and a rotating coupler of the operating panel device shown in FIG. 2 along an x-axis direction;

FIG. 3B is a perspective view illustrating the assembly of the linear transfer and the rotating coupler of the operating panel device shown in FIG. 2 along an −x-axis direction; and

FIG. 4 is a perspective view illustrating a rotation stopper coupled to the rotating coupler of the operating panel device shown in FIG. 2.

### DETAILED DESCRIPTION OF THE EMBODIMENTS

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, and/or sections, these elements, components, regions, and/or sections should not be limited by these terms. These terms are only used to distinguish one element, component, region, and/or section from another element, component, region, and/or section. For example, a first element, component, region, and/or section could be termed a second element, component, region, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Example embodiments may be described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature, their shapes are not intended to illustrate the actual shape of a region of a device, and their shapes are not intended to limit the scope of the example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

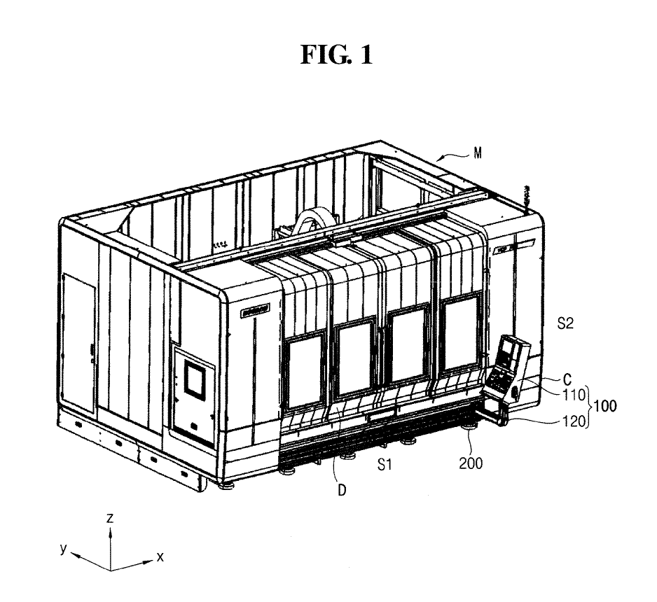

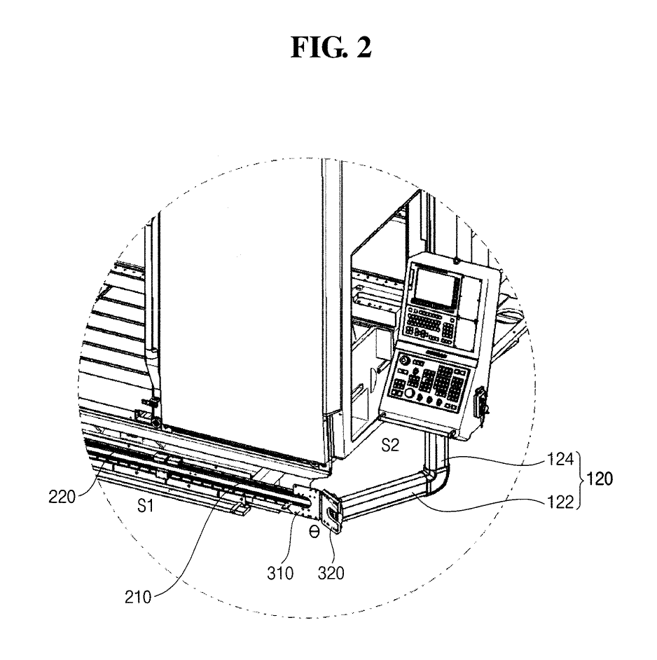

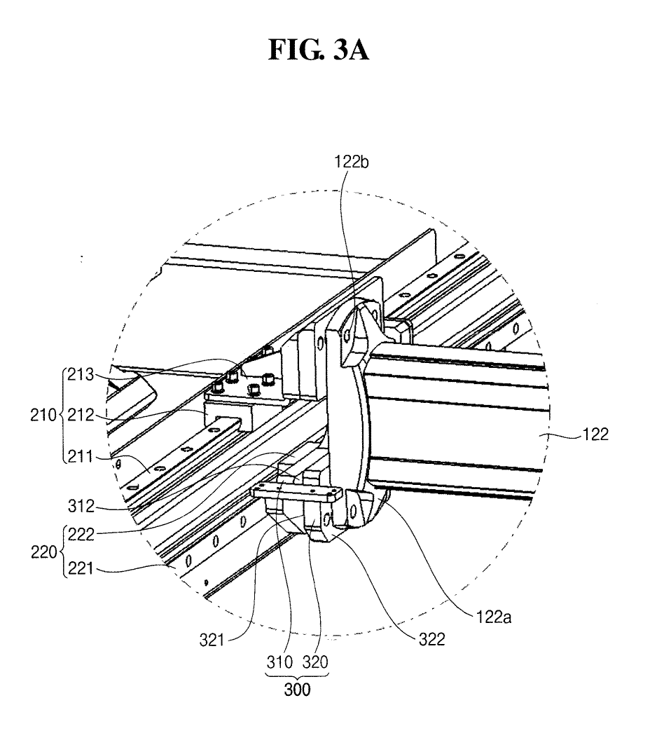

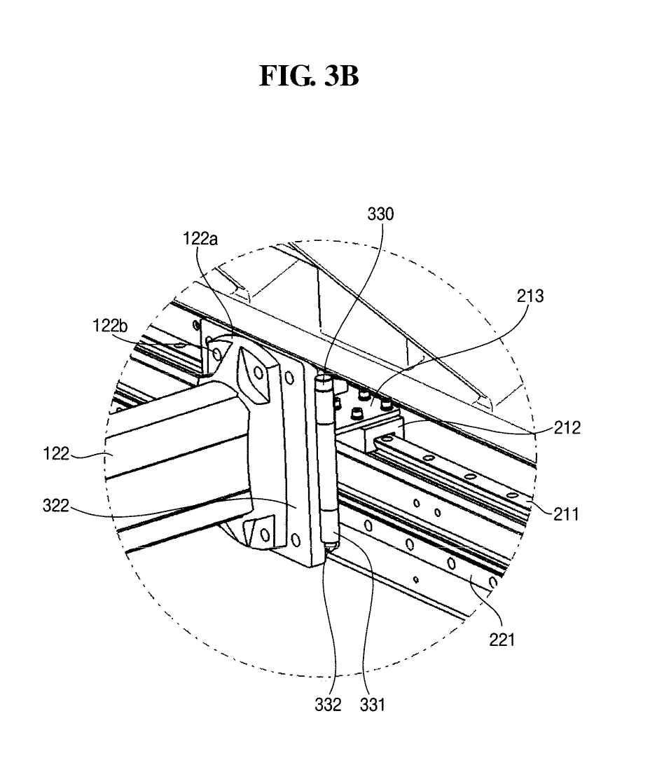

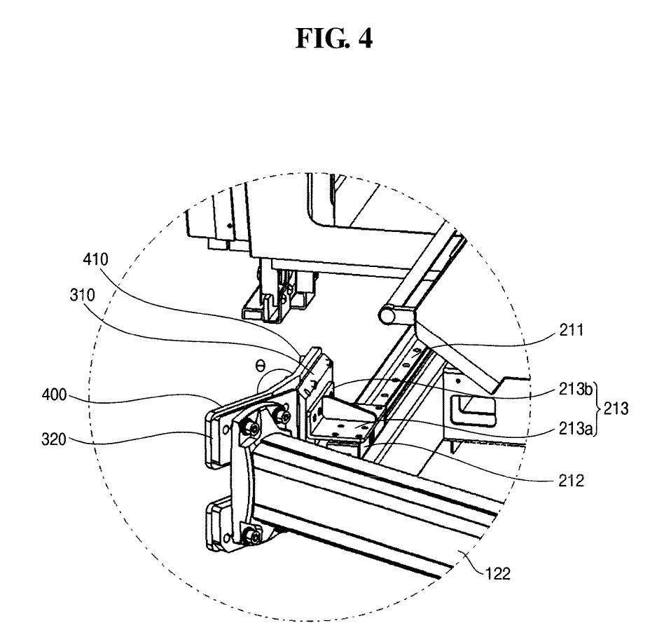

FIG. 1 is a perspective view illustrating an operating panel device in accordance with an example embodiment of the present inventive concept in which the operating panel device is arranged at a longitudinal side of the machining center, and FIG. 2 is a perspective view of the operating panel device in FIG. 1 in which the operating panel device is rotated to a latitudinal side of the machining center. FIG. 3A is a perspective view illustrating an assembly of a linear transfer and a rotating coupler of the operating panel device shown in FIG. 2 along an x-axis direction, and FIG. 3B is a perspective view illustrating the assembly of the linear transfer and the rotating coupler of the operating panel device shown in FIG. 2 along a −x-axis direction. FIG. 4 is a perspective view illustrating a rotation stopper coupled to the rotating coupler of the operating panel device shown in FIG. 2.

Referring to FIGS. 1 to 4, an operating panel device 500 for a machining center M in accordance with an example embodiment of the present inventive concept may include an operating interface 100 having a panel 110 that communicates with the machining center M and a panel support 120 that supports and secures the panel 110, a linear transfer 200 arranged at a longitudinal side S1 of the machining center M and extending in a first direction x and a rotating coupler 300 coupled the operating interface 100 to the linear transfer 200 and conducting a linear motion along the first direction x together with a rotating motion with respect to a third direction z substantially perpendicular to first and second directions x and y in such a configuration that the operating interface 100 may be selectively positioned at one of the longitudinal side S1 and a latitudinal side S2 of the machining center M. In the present example embodiment, the machining center M may have a size that may be defined by a length along the first direction x, a width along the second direction y and a height along the third direction z.

The machining center M may include a movable table (not shown) to which a machining object may be secured, a spindle assembly to which a machining tool may be combined, a column structure for supporting and driving the spindle assembly and various supporting machines such as an automatic tool changer (ATC). Particularly, the above component modules of the machining center may be covered by a housing H having opening doors D, so an interior of the machining center M may be separated from exteriors thereof by the housing H. The opening doors D of the machining center M may be opened and the machining object may be loaded into the machining center and be secured onto the table therein. Then, the opening doors D may be closed in such a way that the inside of the housing H may be closed and separated from outsides of the housing H. Then, the machining process to the machining object may be conducted in the closed inside of the housing H, and the operator of the machining center M may keep his eye on the machining process through a watch window (not shown) of the machining center M. When completing the machining process, the opening doors D may be opened again and the machined object may be unloaded from the machining center M.

The operating interface 100 may be arranged at the longitudinal side S1 of the machining center M in the first direction x with which the opening doors D may also be provided. Hereinafter, the longitudinal side of the machining center at which the opening doors D may be arranged may be referred to as a front side of the machining center M. In the present example embodiment, the operating interface 100 may be arranged at the front side of the machining center M and may include the panel 110 that may be electrically communicated with the numeric controller (not shown) of the machining center M and may supply some machining instructions to the numeric controller and the support 120 to which the panel 110 may be secured.

In the present example embodiment, the machining center M may be shaped into a rectangular defined by a Cartesian coordinate system having the first, second and third directions x, y and z. Thus, both longitudinal side portions S1 may be provided with the machining center in the first direction x and both latitudinal side portions S2 may be provided with the machining center in the second direction y. One of the longitudinal side portions S1 may be the front side of the machining center M and the other may be a back side of the machining center M. While the present example embodiment discloses that the opening doors D are provided with the front portion, the opening doors D would also be provided with the back portion in place of the front portion. The operating interface 100 may move from the longitudinal side portion S1 to the latitudinal side portion S2 just by the rotation between longitudinal side portion S1 and the latitudinal side portion S2.

The panel 110 may include an input section for supplying instruction signals for processing the machining object to the numerical controller and a center display visually displaying operation states and conditions of the machining center M. Thus, the operator may visually verify the operation states and conditions of the machining center M on the center display and may apply some operational instructions to the numerical controller through the input section in a real time.

For example, the panel 110 may include a computer system having a panel process unit (not shown), a display terminal and an input device. The panel process unit may detect various operating signals indicating the operation states and conditions of the machining center M and may analysis and evaluate the operation signals on a basis of signal analysis algorithms. The operation states and conditions of the machining center M and the analysis results may be displayed on the display terminal and the operator may transfer operational instructions based on the displayed operation data on the display terminal.

The panel 110 may be fixed to the panel support 120 that may be shaped into a rod having sufficient rigidity and strength and the panel support 120 may be secured to the rotatable combiner 300. The rotatable combiner 300 may be secure to the linear transfer 200 that may linearly move in the first direction x at the front portion of the machining center M and the panel support 120 may be secured to the rotatable combiner 300, the panel 110 may also move along the first direction x at the front portion.

For example, the panel support 120 may be shaped into a capital letter ‘L’ and may include a horizontal rod 122 that may be combined to the rotatable combiner 300 and a vertical rod 124 that may extend vertically in the third direction z and may support the panel 110. A securing bracket 122a may be provided at an end portion of the horizontal rod 122 and a plurality of bolts 122b may be inserted into an external surface 322 of the rotatable combiner 300 through the securing bracket 122a.

Therefore, the operational interface 100 may be stably secured to the rotatable combiner 300 that may be secured to the linear transfer 200 and may move in the first direction x together with the linear transfer 200.

The linear transfer 200 may be arranged at a lower portion of the front side of the machining center M and may move in the first direction x.

For example, the linear transfer 200 may include a linear motion (LM) guide rail extending in the first direction x at the longitudinal side S1 of the machining center M and a guide block movably combined with the LM guide rail in such a configuration that the guide block moves in the first direction x along the LM guide rail. Variable configurations may be allowable to the LM guide rail so as to increase the linear motion stability of the operating panel device 500.

In the present example embodiment, a pair of the guide rails may be arranged in parallel with each other in the first direction x and the guide block may be arranged at each guide rail. Thus, the rotatable combiner 300 may be secured to the linear transfer 200 at two points by each guide block, thereby improving the moving stability of the rotatable combiner 300 and the operating interface 100 combined to the rotatable combiner 300. Thus, the liner transfer 200 may include a first transfer 210 and the second transfer 220 at the front side of the machining center M.

The first transfer 210 may include a first LM guide rail 211 secured to the longitudinal side S1 of the machining center M in the first direction x, a first guide block 212 combined to the first LM guide rail 211 and moving along the first LM guide rail 211 in the first direction x and a fixing bracket 213 secured to the first guide block 212.

In an example embodiment, the first LM guide rail 211 may have an upper surface coplanar with an x-y plane and the first guide block 212 may be combined with the upper surface of the first LM guide rail 211 in such a way that an upper surface of the first guide block 212 may be coplanar with an x-y plane. That is, the first guide block 212 may be arranged to have a surface vector of the upper surface in parallel with the third direction z.

Particularly, the first LM guide rail 211 may be shaped into a linear rail extending in the first direction x under the opening doors D and the first guide block 212 may enclose an upper portion of the first LM guide rail 211 with making contact with the upper surface of the first LM guide rail 211. Therefore, the first guide block 212 may move along the first LM guide rail 211 by sliding or rolling motion.

The fixing bracket 213 may include a horizontal plate 213a that may be secured to the upper surface of the first guide block 212 and thus have a surface vector in parallel with the third direction z and a vertical plate 213b that may integrally extend from the horizontal plate 213a in one body and have a surface vector in parallel with the second direction y.

The horizontal plate 213a may be coupled to the upper surface of the first guide block 212 and the vertical plate 213b may be coupled to an upper portion of a securing plate 310 of the rotating coupler 300 by a plurality of bolts. Various securing members as well as the bolts may be allowable to the assembling of the horizontal plate 213a and the first guide block 212 and the assembling of the vertical plate 213b and the securing plate 310.

The second transfer 220 may include a second LM guide rail 221 secured to the longitudinal side S1 of the machining center M in the first direction x and a second guide block 222 combined to the second LM guide rail 221 and moving along the second LM guide rail 221 in the first direction x.

In an example embodiment, the second LM guide rail 221 may have an upper surface coplanar with an x-z plane and the second guide block 222 may be combined with the upper surface of the second LM guide rail 221 in such a way that an upper surface of the second guide block 222 may be coplanar with an x-z plane. That is, the second guide block 222 may be arranged to have a surface vector of the upper surface in parallel with the second direction y. Thus, the second guide block 222 may have the same surface vector as the vertical plate 213b in the parallel with the second direction y.

Particularly, the second LM guide rail 221 may be shaped into a linear rail extending in the first direction x under the first LM guide rail 211 and the second guide block 222 may enclose an upper portion of the second LM guide rail 221 with making contact with the upper surface of the second LM guide rail 221. Therefore, the second guide block 222 may move along the second LM guide rail 221 by sliding or rolling motion.

The second guide block 222 may be coupled to a lower portion of the securing plate 310 of the rotating coupler 300, so that the securing plate 310 of the rotating coupler 300 may be secured to both of first and second guide blocks 212 and 222 at upper and lower portions thereof.

That is, the rotating coupler 300 may be individually secured to the linear transfer 200 at two points, thereby minimizing disturbances such as vibrations and torsions when the rotating coupler 300 may move along the linear transfer 200 in the first direction x. Therefore, the operating interface 100, which may be combined to the rotating coupler 300, may be sufficiently prevented from the position deviation due to the disturbances of the rotating coupler 300 and thus may move along the linear transfer 200 at the longitudinal side S1 of the machining center M with high stability.

The rotating coupler 300 may move along the linear transfer 200 in the first direction x and may rotate with respect to a rotation axis in parallel with the third direction z around an end portion of the machining center M, so that the operating interface 100 may be turned to the latitudinal side S2 from the longitudinal side S1 due to the rotation of the rotating coupler 300. Accordingly, the operating interface 100 may be selectively positioned at one of the longitudinal side S1 and the latitudinal side S2 of the machining center M as occasion demands.

In an example embodiments, the rotating coupler 300 may include the securing plate 310 combined to both of the first and the second guide blocks 212 and 222 and moving along the respective guide rail in the first direction x together with the guide blocks 212 and 222, a rotating plate 320 to which the panel support 120 may be secured and a joint member 330 rotatably jointing the rotating plate 320 to the securing plate 310. The rotating plate 320 may rotate with respect to a rotating axis in parallel with the third direction z.

The securing plate 310 may be secured to the first and the second guide blocks 212 and 222 and may move in the first direction x together with the first and the second guide blocks 212 and 222, and the rotating plate 320 may be rotatably combined to the securing plate 310. Therefore, the rotating plate 320 may also move in the first direction x together with the first and the second guide blocks 212 and 222 and may rotate with respect to the securing plate 310. Accordingly, the securing plate 310 may be secured to the linear transfer 200 and the rotating plate 320 may be folded over or spaced from the securing plate 310 by the rotation of the rotating plate 320.

The joint member 330 may rotatably combine the rotating plate 320 to the securing plate 310. Various configurations and structures may be allowable for the joint member 330 as long as the rotating plate 320 may be rotatably combined to the securing plate 310.

In the present example embodiment, the joint member 330 may include a hinge structure that may extend in the third direction z and may be combined across edge portions of the securing plate 310 and the rotating plate 320.

For example, the joint member 330 may include a plurality of hollow joint pieces 331 combining across the edge portions of the securing plate 310 and the rotating plate 320 and extending in the third direction z and a connecting rod 332 penetrating through the hollow joint pieces 331 in the third direction z. The connecting rod 332 may include a head portion having a diameter larger than those of the hollow joint pieces 331 and a body having a diameter smaller than those of the hollow joint pieces 331 and extending downward in the third direction z through the hollow joint pieces 331. Thus, the head portion of the connecting rod 332 may be arranged on the hollow joint pieces 331 and the body of the connecting rod 332 may pass through the hollow joint pieces 331. An end portion of the body may be protruded from a bottom of the hollow joint pieces 331.

For example, when the securing plate 310 may face the rotating plate 320, the hollow joint pieces 331 may be combined across neighboring edge portions by a uniform gap in the third direction z. Thus a plurality of the hollow joint pieces 331 may be alternately arranged in the third direction z and the hollow space of each joint piece 331 may be communicated in the third direction z as a single cylindrical hole while the securing plate 310 and the rotating plate 320 may be combined to each other at the neighboring edge portions thereof. The connecting rod 332 may penetrate through the communicating hollow spaces in the third direction z and may function as a rotating axis of the rotating plate 320 in parallel with the third direction z.

When the rotating plate 320 may be folded over the securing plate 310 in such a way that an outer surface 312 of the securing plate 310 may face an inner surface 321 of the rotating plate 320, the horizontal rod 122 of the panel support 120 may reversely extend in the second direction y as shown in FIGS. 1, 3a and 3b. In such a case, the operating interface 100 may be positioned at the longitudinal side S1 of the machining center M. However, when the rotating plate 320 may rotate with respect to the connecting rod 332 and thus the inner surface 321 of the rotating plate 320 may be spaced apart from the outer surface 312 of the securing plate 310 at a gap angle, the horizontal rod 122 of the panel support 120 may also rotate at the same gap angle θ and, as a result, may extend in the first direction x as shown in FIG. 2. In such a case, the operating interface 100 may be positioned at the latitudinal side S2 of the machining center M.

In the present example embodiment, the rotating coupler 300 may be manually rotated by the operator of the machining center M or other workers handling the machining center M. Otherwise, the rotating coupler 300 may be automatically rotated by a panel controller (not shown), as would be known to one of the ordinary skill in the art.

For example, when packaging the machining center M for the factory shipment, the packaging worker may push the operating interface 100 to the end along the linear transfer 200 in the first direction x, and then may rotate the operating interface 100 with respect to the connecting rod 332 of the joint member 330 such as the hinge structure. As a result of the rotation, the rotating plate 320 may be spaced from the securing plate 310 and the operating interface 100 may move to the latitudinal side S2 from the longitudinal side S1 of the machining center M. Accordingly, the packaging space for the machining center M may be reduced as wide as the width of the operating interface 100. Although the packaging length of the machining center M may be elongated as long as the width of the operating interface 100, the machining center M can be loaded into cargo box of the conventional transfer vehicles by using various cargo supplements. Accordingly, merely rotation of the operating interface 100 may significantly reduce the packaging cost and the transfer cost of the machining center M.

The gap angle θ between the securing plate 310 and the rotating plate 320 may be controlled in such a way that the operating interface 100 may not collide with the machining center M at the latitudinal side S2. For example, a rotation interrupter (not shown) may be provided with the rotating coupler 300 for restricting the gap angle θ within some allowable ranges.

Particularly, a rotation stopper 400 may be further provided with the operating panel device 500. When the rotating plate 320 may rotate back toward the securing plate 310 at the latitudinal side S2 in transferring the machining center M by the transfer vehicle, the operating interface 110 may be damaged in the machining center transfer. For that reason, the rotating coupler 300 may be locked by the rotation stopper 400 when the operating interface 110 may be positioned at the latitudinal side S2 of the machining center M in the machining center transfer.

As shown in FIG. 4, when the securing plate 310 and the rotating plate 320 may be spaced apart from each other by the gap angle θ and the operating interface 110 may be sufficiently moved to the latitudinal side S2 from the longitudinal side S1, the rotation stopper 400 may be detachably coupled to both of the outer surface 312 of the securing plate 310 and the inner surface 321 of the rotating plate 320. For example, the rotation stopper 400 may include a plate structure that may be combined with both of the outer surface 312 of the securing plate 310 and the inner surface 321 of the rotating plate 320 by a plurality of bolts.

Accordingly, the rotation of the rotating plate 320 may be prevented by the rotation stopper 400 and the location of the rotating plate 320 may be unchanged in the machining center transfer. As a result, the operating interface 110 may be sufficiently prevented from swing or oscillating in the packaging space when the machining center may be transferred in the cargo box.

When completing the machining center transfer, the rotation stopper 400 may be separated from the securing plate 310 and the rotating plate 320 and then the rotating plate 320 may be rotated back to be folded over the securing plate 310. Therefore, the operating interface 100 may be turned back to the longitudinal side S1 from the latitudinal side S2 of the machining center M. When the operating interface 100 may be located back at the longitudinal side S1, a combiner locker (not shown) may be coupled to the rotating plate 320 in such a configuration that the rotating plate 320 that may be folded over the securing plate 310 may be locked to the first and second guide rails 211 and 221. Thus, the linear motion of the first and the second guide blocks 212 and 222 and the rotation of the rotating plate 320 may be constrained by the combiner locker. That is, the position of the operating interface 100 may be forcibly maintained at the longitudinal side S1 of the machining center M. When the machining center M may be transferred again to another site, the combiner locker may be unlocked from the rotating plate 320.

According to the example embodiments of the operating panel device, the rotating coupler 300 may be combined to the linear transfer 200 moving in the longitudinal direction of the machining center and the operating interface 100 may be combined to the rotating coupler 300.

When packaging the machining center M for the factory shipment, the packaging worker may push the operating interface 100 to the end along the linear transfer 200 in the first direction x, and then may rotate the operating interface 100 with respect to the connecting rod 332 of the joint member 330. As a result of the rotation, the operating interface 100 may move to the latitudinal side S2 from the longitudinal side S1 of the machining center M as a result of the rotation of the rotating plate 320. Thus, the packaging space for the machining center M may be reduced as wide as the width of the operating interface 100 just by the rotation of the rotating plate 320.

Accordingly, merely rotation of the operating interface 100 may significantly reduce the packaging cost and the transfer cost of the machining center M.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. An operating panel device for a machining center having a length in a first direction and a width in a second direction, comprising:
an operating interface having a panel that communicates with the machining center and a panel support that supports and secures the panel;
a linear transfer arranged at a longitudinal side of the machining center and extending in the first direction; and
a rotating coupler coupling the operating interface to the linear transfer and conducting a linear motion along the first direction together with a rotating motion with respect to a third direction substantially perpendicular to the first and the second direction in such a configuration that the operating interface is selectively positioned at one of the longitudinal side and a latitudinal side of the machining center.

2. The operating panel device of claim 1, wherein the linear transfer includes a linear motion (LM) guide rail extending in the first direction at the longitudinal side of the machining center and a guide block movably combined with the LM guide rail in such a configuration that the guide block moves in the first direction along the LM guide rail.

3. The operating panel device of claim 2, wherein the rotating coupler includes a securing plate secured to the guide block and moving in the first direction together with the guide block, a rotating plate to which the panel support is secured and a joint member rotatably jointing the rotating plate to the securing plate.

4. The operating panel device of claim 3, wherein the joint member includes a plurality of hollow joint pieces combining across edge portions of the securing plate and the rotating plate and extending in the third direction and a connecting rod penetrating through the hollow joint pieces in the third direction in such a configuration that the rotating plate rotates with respect to the connecting rod.

5. The operating panel device of claim 3, further comprising a rotation stopper detachably coupled to both of the securing plate and the rotating plate when the rotating plate is spaced apart from the securing plate, thereby preventing the rotating plate from rotating back toward the securing plate, so that the operating interface is forcibly positioned at the latitudinal side of the machining center.
